(19) United States
(12) Patent Application Publication
(10) Pub. No.: US 2018/0137479 A1
(43) Pub. Date: May 17, 2018

(54) SECURE SYSTEM FOR IMPLEMENTING AN INTERNATIONAL CURRENCY UNIT PLATFORM

(71) Applicant: Digifund LLC, La Junta, CO (US)

(72) Inventor: Hassan William Mirakhor, La Junta, CO (US)

(73) Assignee: Digifund LLC, La Junta, CO (US)

(21) Appl. No.: 15/815,602

(22) Filed: Nov. 16, 2017

Related U.S. Application Data
(60) Provisional application No. 62/422,954, filed on Nov. 16, 2016.

(51) Int. Cl. G06Q 20/06; G06Q 40/04; G06Q 20/20; G06Q 20/10

(52) U.S. Cl. CPC G06Q 20/0655; G06Q 20/10; G06Q 20/204; G06Q 40/04

(57) ABSTRACT

As commerce has become more and more digitally based, the financial sector has become increasingly decoupled from the real sector. Filling the gap, the current interest-bearing debt system has shifted risk in an unsustainable manner that stands in contrast to a profit-loss-sharing arrangement. The International Currency Unit (ICU) platform promotes a recoupling of the financial sector with the real sector by providing a more stable risk distribution between parties. In particular, each ICU is generated based on an index, which is based on current values of each of a plurality of real-world currencies. The plurality of real-world currencies may be selected for inclusion in the index based on relative value stability, widespread global acceptance, or any other criteria. As the ICU is tied to current values of a stable set of real-world currencies, fluctuations in the value of the ICU are minimized, which promotes international contract formation.

### BACKGROUND

As digital commerce becomes increasingly global, the need for a unified and secure system for digital contract negotiation, formation and performance, as well as real-time, secure currency exchange is paramount. Currently, a number of challenges create barriers to international contracts. Challenges include, for instance, ambiguities arising through language translation, cultural misalignment of business expectations, disparities in delivery infrastructures, incompatibility between national commercial laws, and the like. Moreover, international contracts may be stymied due to fluctuations in the values of international currencies with respect to one another. This issue may be compounded when there is a delay between the time of agreement and the time of performance. That is, a seller may agree to a price today but may receive a substantially lower actual price at a later date when the transaction or contract is performed. This may occur, for example, when the seller's native currency decreases in value vis-à-vis the buyer's native currency during the delay period. Conversely, the buyer may be required to pay a substantially higher actual price than the agreed price when the buyer's native currency decreases in value vis-à-vis the seller's native currency during the delay period. The uncertainty underlying the above scenarios may thwart international commerce, particularly with respect to the formation of international contracts that routinely entail a delay period between the time of agreement and the time of performance.

It is with respect to these and other general considerations that embodiments have been described. Also, although relatively specific problems have been discussed, it should be understood that the embodiments should not be limited to solving the specific problems identified in the background.

### SUMMARY

The disclosure generally relates to a secure system and interface for executing digital contracts (e.g., digital document agreements) and completing digital transactions utilizing an international currency unit (ICU). In at least some aspects, ICUs may be universally accepted because they are generated based on a real-time exchange index. In particular, ICUs are tied to the current values of a stable set of real-world currencies, thus providing increased value stability and reducing the risks associated with international contract formation and performance.

As commerce has become more and more digitally based, the financial sector has become increasingly decoupled from the real sector. Filling the gap, the current interest-bearing debt system has shifted risk in an unsustainable manner that stands in contrast to a profit-loss-sharing arrangement. The International Currency Unit (ICU) platform promotes a recoupling of the financial sector with the real sector by providing a more stable risk distribution between parties. In particular, each ICU is generated based on an index, which is based on current values of each of a plurality of real-world currencies. The plurality of real-world currencies may be selected for inclusion in the index based on relative value stability, widespread global acceptance, or any other criteria. As the ICU is tied to current values of a stable set of real-world currencies, fluctuations in the value of the ICU are minimized, which promotes international contract formation.

In aspects, a system is provided that includes a processing unit and a memory. The memory stores computer executable instructions that, when executed by the processing unit, cause the system to perform a method. The method includes receiving a selection to post an asset and receiving a selection to purchase the asset at a price. The method further involves generating a digital document and tagging the digital document with an amount of international currency units (ICU). Additionally, the method includes validating the ICU tag and, in response to validating the ICU tag, releasing the amount of ICU.

In further aspects, a method of performing a point-of-sale (POS) transaction using an international currency unit (ICU) is provided. The method includes receiving a selection to initiate a POS transaction for an asset and generating a digital document. The method further includes tagging the digital document with an amount of international currency units (ICU) and validating the ICU tag. In response to validating the ICU tag, the method includes releasing the amount of ICU.

In still further aspects, a computer storage medium is provided. The computer storage medium stores computer-readable instructions that when executed by a processor cause a computing system to receive a selection to purchase an asset at a price. The computer-readable instructions further cause the computing system to generate a digital document and tag the digital document with an amount of international currency units (ICU). Additionally, the computer-readable instructions cause the computing system to validate the ICU tag and, in response to validating the ICU tag, release the amount of ICU.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an exemplary platform for promoting stability in international transactions and investments using an international currency unit (ICU) tied to an index.

FIG. 2 illustrates an exemplary platform for enabling point-of-sale (POS) transactions using an international currency unit (ICU) tied to an index.

FIG. 3 illustrates an exemplary method for calculating an index based on a plurality of legal tender.

FIG. 4 illustrates an exemplary method for converting legal tender into international currency units (ICU) based on the index.

FIG. 5 illustrates an exemplary method for converting international currency units (ICU) into legal tender based on the index.

FIG. 6 illustrates an exemplary method for performing a digital contract using international currency units (ICU).

FIG. 7 illustrates an exemplary method for performing a point-of-sale (POS) transaction based on transfer of international currency units (ICU).

FIG. 8 illustrates an exemplary method for performing a transaction based on transfer of international currency units (ICU).

FIG. 9 illustrates a block diagram of a sharing platform based on international currency units (ICU).

FIG. 10 illustrates one example of a suitable operating environment in which one or more of the present embodiments may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As described above, the disclosure generally relates to secure system and interface for executing digital contracts and completing digital transactions utilizing an international currency unit (ICU). In at least some aspects, the ICU platform promotes a recoupling of the financial sector with the real sector by providing a more stable risk distribution between parties. In particular, each ICU is generated based on an index, which is based on current values of each of a plurality of real-world currencies. The plurality of real-world currencies may be selected for inclusion in the index based on relative value stability, widespread global acceptance, or any other criteria. As the ICU is tied to current values of a stable set of real-world currencies, fluctuations in the value of the ICU are minimized, which stabilizes value, reduces risk, and promotes international contract formation. For instance, based on the increased stability of the ICU, benefits include: eliminating Fiat currency (i.e., currency backed by the particular government that issued the currency) transaction fees, eliminating the need to store Fiat currency values locally, simplifying common costs for transactions, eliminating the need for trade gap insurance, expediting transactions, and increasing short and long term value of holding ICU.

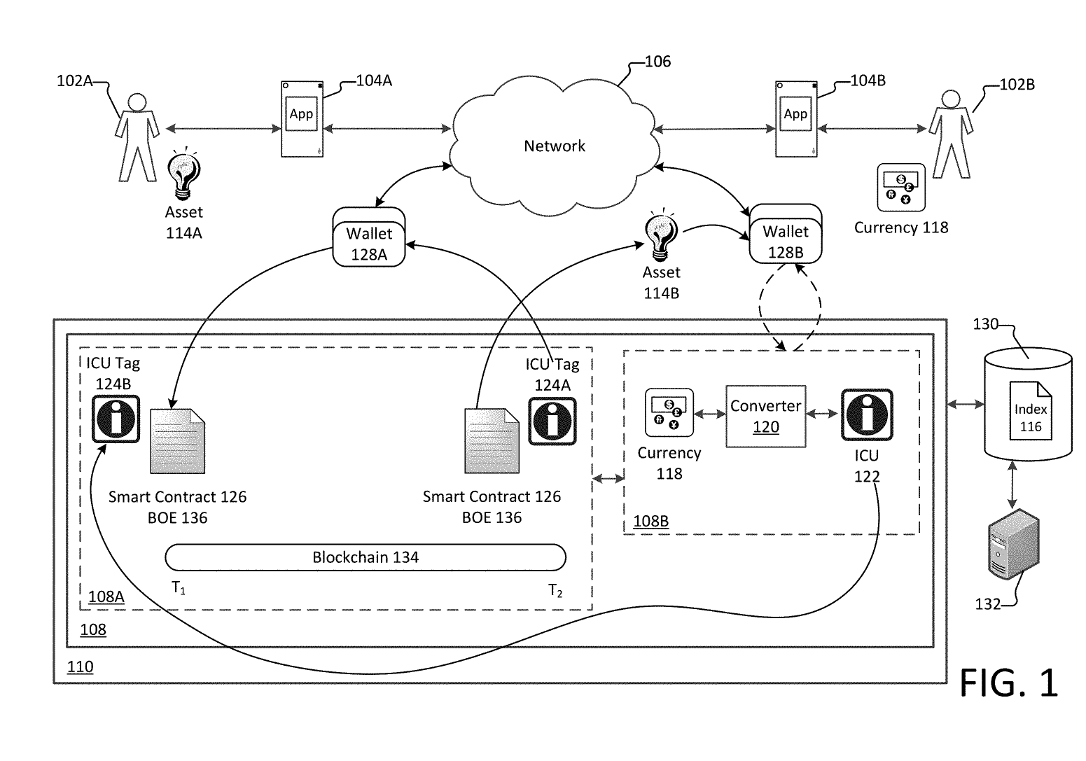

FIG. 1 illustrates an exemplary platform for promoting stability in international transactions and investments using an international currency unit (ICU) tied to an index.

As illustrated, one or more client computing devices 104 (e.g., client computing devices 104A and 104B) may interface with International Currency Unit (ICU) platform 108 (including contract component 108A and exchange component 108B) to conduct an international transaction. In a basic configuration, the one or more client computing devices 104 are operated by one or more users 102 (e.g., user 102A and user 102B). For example, user 102A may deliver an asset in exchange for payment (e.g., seller, payee, supplier, vendor, retailer, venture capital recipient, etc.) and user 102B may deliver payment in exchange for the asset or an interest in the asset (e.g., buyer, payor, customer, venture capitalist, etc.).

In a basic configuration, the one or more client computing devices 104 may be personal or handheld computers having both input elements and output elements for communicating with the ICU platform 108 over a network 106. For example, the one or more client computing devices 104 may include one or more of: a mobile telephone; a smart phone; a tablet; a phablet; a smart watch; a wearable computer; a personal computer; a desktop computer; a laptop computer; a gaming device/computer; a television; and the like. This list is exemplary only and should not be considered as limiting. Any suitable client computing device for accessing the ICU platform 108 may be utilized. In at least some aspects, client computing devices 104 may be remotely located from one another; and in further aspects, client computing devices 104 may be located internationally.

ICU platform 108 may be implemented by one or more server computing devices 110, e.g., within a cloud-based computing environment. In some aspects, the one or more client computing devices 104 and the one or more server computing devices 110 may communicate over network 106. For example, network 106 may include multiple networks, e.g., an enterprise intranet, the Internet, etc. In this regard, network 106 may include a Local Area Network (LAN), a Wide Area Network (WAN), the Internet, and communication may be conducted via wireless and/or wired transmission mediums. In further aspects, the one or more client computing devices 104 may communicate with some components of the system via a local network (e.g., an enterprise intranet), whereas the one or more server computing devices 110 may communicate with other components of the system via a wide area network (e.g., the Internet). In addition, the aspects and functionalities described herein may operate over distributed systems (e.g., a cloud-based computing environment), where application functionality, memory, data storage and retrieval and various processing functions may be operated remotely from each other over a distributed computing network, such as the Internet or an intranet.

As described above, the ICU platform 108 may be implemented by one or more server computing devices 110. In a basic configuration, each server computing device 110 may include at least a processing unit and a system memory for executing computer-readable instructions, e.g., an ICU application, for implementing the ICU platform 108. The ICU platform 108 may provide an interface to enable users 102A and 102B to conduct international transactions utilizing an international currency unit (ICU). For instance, users 102A and 102B may initiate, negotiate, agree, verify, and/or perform with respect to an electronic transaction or contract via the ICU platform 108. For purposes of the present disclosure, while some transactions may not involve formation and performance of a contract in a formal sense, such transactions may be described in terms of the formation and performance of a contract for the sake of consistency and simplicity.

As should be appreciated, a number of challenges create barriers to international contracts. Challenges include, for instance, ambiguities arising through language translation, cultural misalignment of business expectations, disparities in delivery infrastructures, incompatibility between national commercial laws, and the like. Moreover, international contracts may be stymied due to fluctuations in the values of international currencies with respect to one another. This issue may be compounded when there is a delay between the time of agreement and the time of performance. That is, a seller may agree to a price today but may receive a substantially lower actual price at a later date when the transaction or contract is performed. This may occur, for example, when the seller's native currency decreases in value vis-à-vis the buyer's native currency during the delay period. Conversely, the buyer may be required to pay a substantially higher actual price than the agreed price when the buyer's native currency decreases in value vis-à-vis the seller's native currency during the delay period. The uncertainty underlying the above scenarios may thwart international commerce, particularly with respect to the formation of international contracts that routinely entail a delay period between the time of agreement and the time of performance. Implementation of the ICU platform 108 addresses at least some of the above challenges to facilitate the formation and performance of international contracts.

ICU platform 108 may implement an interface that enables users to enter into international smart contracts and/or digital bills of exchange. As described further herein, a “smart contract” involves a digital agreement that is formed, verified, and/or enforced within a computer-implemented environment. Generally, a “bill of exchange” (BOE) is a written commitment by a funding party (payor) to pay a certain sum either on demand or at a specified time, where the certain sum is paid to a specified funded party (payee) or to one presenting the bill of exchange. A digital BOE may be redeemable and transferrable and may contain proof of ownership, deed information and/or access to funds by the bearer of the BOE. An “international” smart contract (or an international BOE) involves at least one party located in a remote location, e.g., another nation. Similarly, a “bill of lading” (BOL) is a written commitment issued by a carrier (or carrier agent) that acknowledges receipt of cargo for shipment. The digital BOL may be redeemable and transferrable and may contain proof of ownership, deed information and/or access to funds by the bearer of the BOL. An “international” smart contract (or an international BOL) involves at least one party located in a remote location, e.g., another nation. In some aspects, a digital BOE may be used for digital assets (e.g., debits or credits to a banking account) and a digital BOL may be used for tangible assets (e.g., goods). In further aspects, for tangible assets, a digital BOL may be used throughout the disclosure herein in place of a digital BOE. Parties to a smart contract may include real persons or entities. The present disclosure relates generally to a computer-implemented environment and the terms smart contract and contract may be used interchangeably herein.

In at least some aspects, a transaction may not be defined by a traditional buyer and seller. For instance, a currency exchange transaction may simply involve a first entity providing a first currency to a second entity in exchange for a second currency, where the amount of the first currency provided and the second currency received is based on the current exchange rate between the two currencies. Alternatively, such a transaction may be viewed as each entity being both a buyer and a seller (i.e., the first entity being the seller of the first currency, buyer of second currency; and the second entity being the buyer of the first currency, seller of the second currency). Traditionally, one entity would be more incentivized to sell rather than buy based on the current exchange rate between the first and second currencies. However, by stabilizing the exchange rate between the ICU and fiat currencies, currency exchange between the ICU and fiat currencies is facilitated, thereby facilitating international transactions that rely on such currency exchanges.

For the purposes of this disclosure, formation of a contract occurs upon agreement between the parties with respect to, at least, an asset and a price. Parties may further agree that performance will occur at some time in the future (e.g., a performance time), which may be a specified time, a specified period of time or even an undesignated time in the future (e.g., payment upon delivery). Formation of a BOE occurs upon a written commitment by the funding party to pay a certain sum upon demand or at a specified time, and performance of the BOE occurs when the certain sum is transferred to the one presenting the instrument. The formation of a contract and/or a BOE occurs at a “formation time” associated with the time of agreement or the time of commitment (e.g., time of execution or effective date for a contract or BOE). Performance of a contract occurs upon delivery of the asset and receipt of payment at the performance time. Performance of a BOE occurs upon delivery of the certain sum at the performance time. In some cases, a BOE may be provided as payment in exchange for the asset. As detailed above, a BOE is a redeemable, transferrable instrument. In the case of a contract or a BOE, a “delay period” is defined as the period of time between the formation time (T₁) and the performance time (T2).

As detailed above, the ICU platform 108 provides an interface for initiating a contract between users 102A and 102B. For example, to initiate a contract, user 102A may post an asset 114A via the ICU platform 108. Asset 114A may be equity (e.g., in a business venture, company, invention, etc.), goods, services, property (real, personal, or intellectual), and the like. As used herein, “posting” an asset includes making the asset available to other users for investment, sale, lease, bid, etc.

The ICU platform 108 may further provide an interface for negotiation regarding an asset. As used herein, a negotiation phase is defined as a period of time after posting an asset and prior to agreement during which time users 102A and 102B determine, at least, an agreed price. In some aspects, the negotiation phase may also include agreeing to a performance time and/or determining characteristics of the asset 114A (e.g., percentage ownership, guaranteed return, quantity, quality, warrantees, etc.), requirements for delivery of the asset 114A (e.g., free of encumbrances, proof of title, risk of transport to buyer or seller, etc.), and the like. As should be appreciated, any other conditions or terms with respect to the contract may be determined during the negotiation phase. In some aspects, a BOE (e.g., BOE 136) may be negotiated as a method of payment for the asset 114A. In this case, a buyer may commit to pay a certain sum for asset 114A and BOE 136 may be in the form of a redeemable, transferrable instrument for payment of the certain sum.

The following simplified discussion regarding the initiation, negotiation and formation of a contract is provided for the purpose of introducing applicable terms. In some instances, the negotiation phase may be brief. That is, user 102A may post asset 114A, along with a posted price and posted performance time. User 102B may accept these terms without countering, thereby determining an agreed price and an agreed performance time for the contract. In this case, user 102B may simply click “accept” within an interface of the ICU platform 108 to form a contract with user 102A. In another example, user 102A may post the asset 114A with a request for offers or bids from one or more users 102B. In this case, in response to the post, user 102B may input an offered price and/or an offered performance time for asset 114A via ICU platform 108. If the offered price and offered performance time are acceptable to user 102A, user 102A may accept these terms without countering, thereby determining an agreed price and an agreed performance time and forming a contract with user 102B. Alternatively, user 102A may accept the offered performance time, thereby determining an agreed performance time, but may counter with respect to the offered price, e.g., by inputting a counter price via ICU platform 108. Thereafter, user 102B may accept the countered price thereby determining an agreed price and forming a contract with user 102A. For purposes of this simplified discussion, the agreed price and the agreed performance time are “determined” upon an offer and acceptance by the parties; and, upon determining the agreed price and the agreed performance time, a contract is formed between user 102A and user 102B at formation time, T₁. However, as should be appreciated, any combination or number of interactions between user 102A and user 102B may be supported by ICU platform 108 to facilitate the formation of a contract.

However, the initiation, negotiation and formation of international contracts may be more complicated than the simplified discussion above. For example, parties considering an international contract may have concerns about currency volatility and risk allocation. In elementary terms, one or both parties may be concerned about anticipated fluctuations in the value of one national currency vis-à-vis another national currency. Based on this perceived or real risk, one or more of the parties may be reluctant to enter into an international contract. For example, if the user 102A (e.g., recipient of funds) anticipates a decreasing national currency value, user 102A may be concerned that a price negotiated for an asset today may result in a lower actual price at the performance time of the contract in the future. Indeed, based on such anticipation, user 102A may opt to negotiate for a higher price, potentially resulting in a breakdown in negotiations with user 102B. Similarly, if user 102B (e.g., provider of funds) anticipates a decreasing national currency value, user 102B may be concerned that a price negotiated for an asset today may result in a higher actual price at the performance of the contract in the future. Accordingly, user 102B may opt to negotiate for a lower price, potentially resulting in a breakdown in negotiations with user 102A. In short, the parties' anticipations (whether real or perceived) with respect to fluctuations in the currency market may stifle international contract negotiation and formation.

When parties are unwilling or unable to accept the risks outlined above, international contracts are inhibited. As a result, the financial sector has become increasingly decoupled from the real sector. Filling the gap, the current interest-bearing debt system has shifted risk in an unsustainable manner and stands in contrast to a profit-loss-sharing arrangement. The ICU platform 108 promotes a recoupling of the financial sector with the real sector by providing a more stable risk distribution between parties. In particular, the ICU platform 108 allows for risk/equity-based private and public crowd transactions by increasing the stability of the digital currency market. As will be further outlined below, the ICU platform 108 is based on an international currency unit (ICU) which is indexed to real-world currencies in near real time.

In aspects of the present disclosure, each ICU (e.g., ICU 122) may be valued based on an exchange index 116. Exchange index 116 may further be based on current values of one or more types of legal tender, e.g., currency, precious metals, precious stones, etc. For instance, exchange index 116 may be based on a plurality of real-world currencies, which may be selected based on relative value stability, widespread global acceptance, or any other criteria. The plurality of real-world currencies may include widely recognized currencies, such as the U.S. dollar, British pound sterling, Japanese yen, Euro, Chinese yuan, etc. In some aspects, the plurality of real-world currencies may involve a relatively small number of currencies, e.g., from about three to about ten selected currencies, and the plurality of real-world currencies may be relatively fixed for a period of time to promote stability, e.g., a term of one, five, or more years. Additionally or alternatively, exchange index 116 may be based on current exchange values of a plurality of precious metals (e.g., gold, silver, platinum, etc.), precious stones (e.g., diamonds, sapphires, etc.), and the like. The current values of each of the plurality of real-world currencies, precious metals, precious stones, etc., may be based on their current exchange rates on a reliable market (e.g., London market, New York market, Tokyo market, etc.) and may be combined within the exchange index 116 on a regular, real-time basis (e.g., every minute on the minute, every hour on the hour, every day at the same time, etc.). “Combining” the values of the plurality of real-world currencies, precious metals, etc., into the exchange index 116 may involve a simple average, a weighted average, or any other suitable function of the values. In aspects, exchange index 116 may be calculated by server computing device 132 and may be stored in a storage location 130 associated with ICU platform 108.

In some aspects, exchange index 116 may be the Special Drawing Right (SDR) index or may be a function of the SDR index. The SDR index is an international reserve asset created by the International Monetary Fund (IMF) to supplement the reserves of member countries. The SDR index is currently based on the U.S. dollar, British pound sterling, Japanese yen, and Euro, and will be expanded to include the Chinese Renminbi (RMB). An SDR unit is neither a currency, nor a claim on the IMF, but a potential claim on the currencies of IMF members. The value of the SDR is calculated in terms of the U.S. dollar as the sum of specific amounts of each basket currency valued in U.S. dollars, based on exchange rates quoted at noon each day in the London market.

As should be appreciated, exchange index 116 may be the SDR index, a function of the SDR index, or any other suitable index for alleviating the effects of value fluctuations in the international currency market on the value of ICUs. Returning to the examples detailed above, consider user 102A who offers asset 114A for sale, investment, etc., via ICU platform 108. For instance, user 102A may access the ICU platform 108 using a client computing device 104A via a client ICU app, a browser interface, or otherwise. User 102A may further be associated with a secure wallet 128A. Wallet 128A may be an extension of the client ICU app or otherwise hosted by or associated with ICU platform 108. In some cases, user 102A may post an asking price for asset 114A; in others, user 102A may place asset 114A up for bid, etc.

User 102B may accept the asking price or offer a price for asset 114A. Similar to user 102A, user 102B may access ICU platform 108 using a client computing device 104B via a client ICU app, a browser interface, or otherwise. User 102B may further be associated with a secure wallet 128B, which may be an extension of a client ICU app or otherwise hosted by or associated with ICU platform 108. In some cases, user 102B may fund wallet 128B with ICU 122. In other aspects, user 102B may fund wallet 128B with currency 118, which may be any national currency (e.g., U.S. dollar, British pound sterling, Japanese yen, Euro, Chinese RMB, Argentine peso, Australian dollar, Iraqi dinar, etc.), digital currency (e.g., Bitcoin®, Litecoin®, Ethereum®, Peercoin®, etc.), precious metal (e.g., gold, silver, etc.), and the like. Wallet 128B may further be in communication with an exchange component 108B of ICU platform 108. Exchange component 108B may include converter 120 for generating ICU 122 from currency 118 based on exchange index 116. As mentioned above, exchange index 116 may be calculated in near real time, such that the value of each generated ICU 122 is based on a current, real-world currency exchange.

In some cases, as described above, user 102A and user 102B may negotiate a price and/or a performance time for conveying all or a portion of asset 114A. In some cases, asset 114A may be tangible real or personal property and conveyance of asset 114A may include transferring title and possession of asset 114A. In other cases, asset 114A may be intangible and an interest or equity in asset 114A may be conveyed. Whether asset 114A is tangible or intangible, users 102A and 102B may elect to enter into a contract for conveyance of asset 114A. As detailed above, the contract may be a smart contract, which is a digital agreement that is formed, verified, and/or enforced within a computer-implemented environment. In aspects, the contract is formed upon agreement between users 102A and 102B as to the terms for conveying asset 114A. Such terms include, at least, agreement as to price, and may include agreement as to performance time. Upon entering into a contract, e.g., smart contract 126, the smart contract 126 may be tagged with ICU 122 as a guarantee of payment by user 102B. For instance, ICU tag 124B represents an amount of funds in ICU 122 supplied by user 102B to secure smart contract 126. The ICU tag 124B may represent the full price or any portion thereof, e.g., down payment, earnest money, etc. In some aspects, user 102B may authorize ICU tag 124B to be associated with smart contract 126 at formation time, T₁. In further aspects, to protect the buyer, ICU tag 124B may revert to user 102B if the terms of smart contract 126 are not fulfilled.

In some cases, user 102B may elect to provide payment in the form of a digital bill of exchange (BOE) 136. In this case, BOE 136 may represent a commitment by user 102B to pay the certain sum (agreed price) at the performance time. In this case, the BOE 136 rather than the smart contract 126 may be secured by ICU tag 124B. As noted above, the ICU tag 124B may represent the full price or any portion thereof, e.g., down payment, earnest money, etc. In some aspects, user 102B may authorize ICU tag 124B to be associated BOE 136 at formation time, T₁. In further aspects, to protect the buyer, ICU tag 124B may revert to user 102B if the terms of smart contract 126 are not fulfilled, e.g., asset 114A is not delivered. In further examples, upon performance, ICU tag 124B may be retagged to user 102A and BOE 136 may serve as a receipt of payment for user 102B.

In further aspects, the smart contract 126 and/or the BOE 136 may be validated after formation. For instance, validation may be accomplished using blockchain 134, which is a public ledger of all transactions hosted by the ICU platform 108. In aspects, blockchain 134 may be any blockchain now known or developed in the future. Moreover, blockchain 134 may be represented by one or more side chains, with each side chain hosted by a different entity. For instance, blockchain 134 may include a single public chain hosted by any third party entity, such as Bitcoin®, Ethereum®, etc.; alternatively, blockchain 134 may include a single private chain hosted or controlled by the ICU platform 108. Additionally or alternatively, blockchain 134 may include a combination of multiple side chains, which may be hosted by any combination of public or private entities. In aspects, a user may select different blockchains for different transactions. In this way, blockchain 134 may be an “agnostic” blockchain.

With respect to blockchain 134, each transaction may be represented by a block, which is added to the blockchain 134 in chronological order and includes a hash of the previous block. In order to validate each block, the hash of the block is analyzed with respect to the hash of the previous block up to a genesis block. A transaction may occur between digital addresses (e.g., wallets 128A and 128B) and, based on the blockchain 134, value attributable to each digital address may be determined at any given time in the history of the blockchain 134, serving as confirmation that funds pledged (i.e., ICU tag 124B) are sufficient for the transaction and preventing “double-spending” of ICU 122. In aspects, due to the processing-intensive requirements of validating the blockchain 134, “mining” nodes are utilized to provide additional processing resources and more rapid validation. Even so, validation may result in at least some delay period between the formation time (T₁) and the performance time (T2).

Additionally, as discussed above, other reasons for a delay period between T₁ and T2 may include time required to verify title to property, time required to secure financing, time required to manufacture the asset, and the like. For some transactions, the delay period may be a matter of minutes, whereas in other transactions the delay period may be weeks or months. As should be appreciated, the longer the delay period, the more likely that value fluctuations in the currency market may affect the actual price delivered by the seller (e.g., user 102A) and received by the buyer (e.g., user 102B). As a result of this increased risk, transactions involving longer delay periods may be stymied. It is with respect to the delay period and the attendant market hindrances that the present disclosure is directed.

With respect to the example above, the asset 114A may be conveyed to user 102B and ICU tag 124B may be retagged to user 102A (i.e., ICU tag 124A) at the performance time. In some cases, smart contract 126 may include triggers whereby all or a portion of ICU tag 124B may be retagged to user 102A at various stages of contract completion. Upon retagging, ICU tag 124A may be added automatically to wallet 128A in the form of ICU 122. Alternatively, wallet 128A may be in communication with exchange component 108B of ICU platform 108 (communication not shown). In this case, converter 120 may exchange ICU 122 for currency 118 based on exchange index 116. In this case, currency 118 may be the native currency of user 102A or any other real-world or digital currency. As should be appreciated, fluctuations in the value of currency 118 between T₁ and T2 are minimized where currency 118 is converted from ICU 122 based on exchange index 116. Moreover, where fluctuations in the values of global currencies vis-à-vis one another are minimized during the delay period, stability is increased and perceived risk is reduced, promoting international contracts. In aspects, based on the increased stability afforded by the ICU platform 108, at least the following risk/equity sharing models may be enabled: alternate venture capital, agriculture, entertainment, human capital, simple purchases, and the like. Additionally, digital currency-based crowdfunding may be promoted by offering the ICU platform 108, including digital currency exchange, to third party funders.

As should be appreciated, the various devices, components, etc., described with respect to FIG. 1 are not intended to limit the systems and methods to the particular components described. Accordingly, additional topology configurations may be used to practice the methods and systems herein and/or some components described may be excluded without departing from the methods and systems disclosed herein.

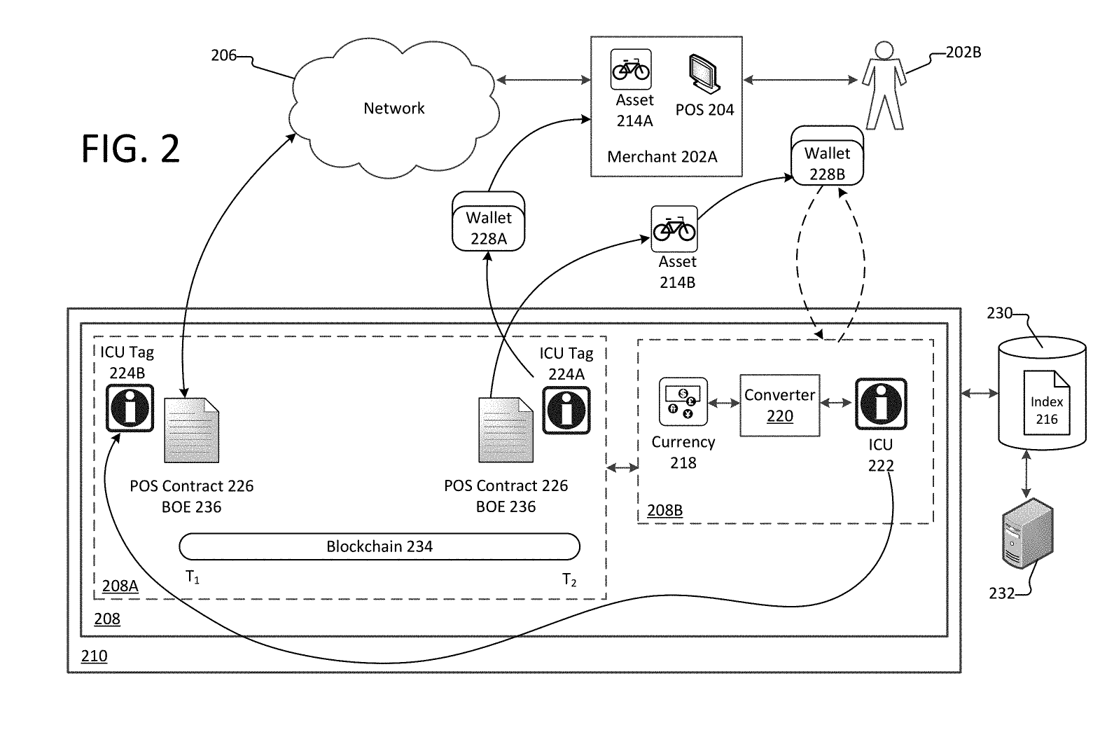

FIG. 2 illustrates an exemplary platform for enabling point-of-sale (POS) transactions using an international currency unit (ICU) tied to an index.

As illustrated, user 202B may interact with POS interface 204 to initiate a point-of-sale transaction with merchant 202A. In a basic configuration, the POS interface 204 may be associated with or incorporated into a computing device for accessing ICU platform 208. In some aspects, merchant 202A may be a recipient of funds (e.g., seller, payee, supplier, vendor, retailer, etc.) and user 202B may be a provider of funds (e.g., buyer, payor, customer, venture capitalist, etc.).

Similar to ICU platform 108, ICU platform 208 may be implemented by one or more server computing devices 210, e.g., within a cloud-based computing environment. In some aspects, the POS interface 204 and the one or more server computing devices 210 may communicate via network 206, e.g., a local network (e.g., an enterprise intranet) or a wide area network (e.g., the Internet). In addition, the aspects and functionalities described herein may operate over distributed systems (e.g., a cloud-based computing environment), where application functionality, memory, data storage and retrieval and various processing functions may be operated remotely from each other over a distributed computing network, such as the Internet or an intranet.

In a basic configuration, each server computing device 210 may include at least a processing unit and a system memory for executing computer-readable instructions for implementing the ICU platform 208. As with ICU platform 108, ICU platform 208 provides an interface to enable user 202B to conduct transactions utilizing an international currency unit (ICU). For instance, user 202B may initiate an electronic POS transaction or POS contract via the ICU platform 208. For purposes of the present disclosure, while POS transactions may not involve formation and performance of a contract in a formal sense, such POS transactions will be described in terms of the formation and performance of a contract for the sake of consistency and simplicity. For example, user 202B may select an asset 214A offered by merchant 202A at an advertised price. Asset 214A may goods, services, property (real, personal, or intellectual), and the like.

User 202B may further interact with ICU platform 208 via POS interface 204 to purchase the asset 214A from merchant 202A. For instance, user 202B may select asset 214A for purchase and may initiate a POS contract 226 via the ICU platform 208. In aspects, user 202B may be associated with a secure wallet 228B, which may be hosted by or associated with ICU platform 208. In some cases, user 202B may fund wallet 228B with ICU 222. In other aspects, user 202B may fund wallet 228B with currency 218, which may be any national currency (e.g., U.S. dollar, British pound sterling, Japanese yen, Euro, Chinese RMB, Argentine peso, Australian dollar, Iraqi dinar, etc.), any digital currency (e.g., Bitcoin®, Litecoin®, Ethereum®, Peercoin®, etc.), any precious metal (e.g., gold, silver, etc.), and the like. Wallet 228B may further be in communication with exchange component 208B of ICU platform 208. Exchange component 208B may include converter 220 for generating ICU 222 from currency 218 based on exchange index 216. As mentioned above, exchange index 216 may be calculated in near real time, e.g., by server computing device 232, such that the value of each generated ICU 222 is based on the current, real-world values for a plurality of currencies, precious metals, etc. Exchange index 216 may further be stored in a storage location 230 in communication with ICU platform 208. As the value of ICU 222 is based on a combined value of indexed currencies, the value of ICU 222 is less susceptible to fluctuations in value.

In some examples, exchange index 216 may be the Special Drawing Right (SDR) index. As detailed above, the SDR index is currently based on the U.S. dollar, British pound sterling, Japanese yen, and Euro, and will soon be expanded to include the Chinese Renminbi (RMB). The value of the SDR unit is calculated in terms of the U.S. dollar as the sum of specific amounts of each basket currency valued in U.S. dollars, based on exchange rates quoted at noon each day in the London market. As should be appreciated, exchange index 216 may be any other suitable index for alleviating the effects of value fluctuations in the currency market on the value of ICU 222.

In some cases, POS contract 226 may be formed when user 202B initiates a POS transaction for purchase of asset 214A at the advertised price offered by merchant 202A. While a POS transaction may be initiated for any asset 214A, in some aspects, asset 214A may be a high-priced asset such as real property, a car, a boat, a bicycle, etc. In this case, merchant 202A may require a down payment or other security to remove asset 214A from the open market while processing the POS transaction with user 202B. For instance, POS contract 226 may be tagged with ICU 222, funded by wallet 228B, as a guarantee of payment by user 202B. That is, ICU tag 224B represents an amount of ICU 222 supplied by user 202B to secure POS contract 226. The ICU tag 224B may represent the full price or any portion thereof. In some aspects, user 202B may authorize ICU tag 224B to be associated with POS contract 226 and, to protect the buyer, ICU tag 224B may revert to user 202B if the terms of POS contract 226 are not fulfilled, e.g., asset 214A is not delivered or is defective (e.g., refused by user 202B upon delivery).

In some aspects, as detailed above, user 202B may further elect to provide payment in the form of a digital bill of exchange (BOE) 236. BOE 236 may represent a commitment by user 202B to pay the certain sum (advertised price) by a redeemable, transferrable instrument. In this case, the BOE 236, rather than the POS contract 226, may be secured by ICU tag 224B. As provided above, the ICU tag 224B may represent the full price of asset 214A or any portion thereof. In some aspects, user 202B may authorize ICU tag 224B to be associated BOE 236 and, to protect the buyer, ICU tag 224B may revert to user 202B if the terms of POS contract 226 are not fulfilled, e.g., asset 214A is not delivered or is defective (e.g., refused by user 202B upon delivery).

As should be appreciated, as a result of the stability of ICU 222 within the global currency market, merchant 202A may be motivated to accept payment for asset 214A in the form of ICU 222. Moreover, merchant 202A may be willing to offer asset 214A at a lower advertised price to induce user 202B to make payment in ICU 222. In this respect, both buyers and sellers may be benefited, bolstering the sale of goods and services, particularly in locations where the local currency value is unstable and/or weak with respect to other global currencies.

As described above with respect to FIG. 1, the POS contract 226 and/or the BOE 236 may be validated, e.g., using blockchain 234. Upon validation, asset 214A may be conveyed to user 202B and ICU tag 224B may be retagged to merchant 202A (i.e., ICU tag 224A). In some aspects, ICU tag 224A may be added automatically to wallet 228A associated with merchant 202A. In other aspects, wallet 228A may be in communication with exchange component 208B of ICU platform 208 (communication not shown). In this case, converter 220 may exchange ICU 222 for currency 218 based on exchange index 216. In this case, currency 218 may be local currency of merchant 202A or any other real-world or digital currency.

As should be appreciated, the various devices, components, etc., described with respect to FIG. 2 are not intended to limit the systems and methods to the particular components described. Accordingly, additional topology configurations may be used to practice the methods and systems herein and/or some components described may be excluded without departing from the methods and systems disclosed herein.

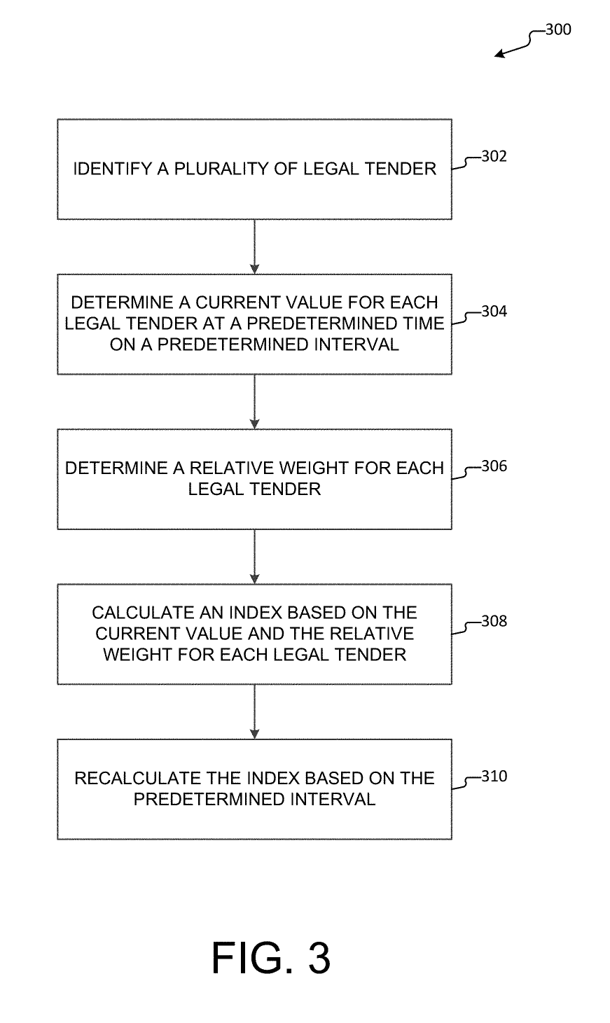

FIG. 3 illustrates an exemplary method for calculating an index based on a plurality of legal tender.

Method 300 begins with identify operation 302, where a plurality of legal tender is identified. As described above, legal tender may include real-world currencies, precious metals, precious stones, etc. Legal tender may be identified based on any suitable selection process, e.g., value stability, global acceptance, and the like. In aspects, real-world currencies may be identified within the plurality of legal tender, including widely recognized currencies, such as the U.S. dollar, British pound sterling, Japanese yen, Euro, Chinese yuan, etc. In some aspects, a relatively small number of international currencies may be identified, e.g., from about three to about ten international currencies. Additionally or alternatively, precious metals (e.g., gold, silver, platinum, etc.), precious stones (e.g., diamonds, sapphires, etc.), etc., may be identified within the plurality of legal tender.

At determine value operation 304, a current value for each legal tender may be determined. For example, current values of each of the plurality of legal tender, including real-world currencies, precious metals, precious stones, etc., may be determined based on their current exchange rates on a reliable market (e.g., London market, New York market, Tokyo market, etc.) at a predetermined time (e.g., at noon, at the top of the hour, etc.) on a predetermined interval (e.g., daily, hourly, minute-by-minute, second-by second, etc.). As should be appreciated, any suitable method for determining current values for each of the plurality of legal tender may be employed without departing from the present disclosure.

At determine weight operation 306, a relative weight for each legal tender may be determined. For instance, more stable legal tender may be given a higher relative weight, more widely accepted legal tender may be given a higher relative weight, and the like. In aspects, any suitable system for assigning relative weights to each legal tender may be employed. Moreover, in some aspects, relative weights may be adjusted based on the current value of each legal tender, a historical performance of each legal tender, changes in market acceptance for each legal tender, and the like. The relative weights may be evaluated and adjusted at the predetermined time on the predetermined interval, or at an alternative time based on an alternative interval. As should be appreciated, any suitable method for assigning and/or adjusting the relative weights for each of the plurality of legal tender may be employed without departing from the present disclosure.

At calculate operation 308, an index may be calculated based at least in part on the current value and relative weight of each of the plurality of legal tender. For instance, the index may be calculated as a weighted average of the current values. Alternatively, the index may be based on any suitable function of the current values and relative weights of the plurality of legal tender.

At recalculate operation 310, the index may be recalculated on the predetermined interval. For instance, the index may be recalculated daily, hourly, minute-by-minute, second-by second, etc., based on the current values and relative weights of the plurality of legal tender at the predetermined time (at noon, at the top of the hour, etc.). Accordingly, the index may be calculated in near real time, e.g., at the predetermined time on the predetermined interval.

As should be appreciated, FIG. 3 is described for purposes of illustrating the present methods and systems and is not intended to limit the disclosure to a particular sequence of steps, e.g., steps may be performed in differing order, additional steps may be performed, and disclosed steps may be excluded without departing from the present disclosure.

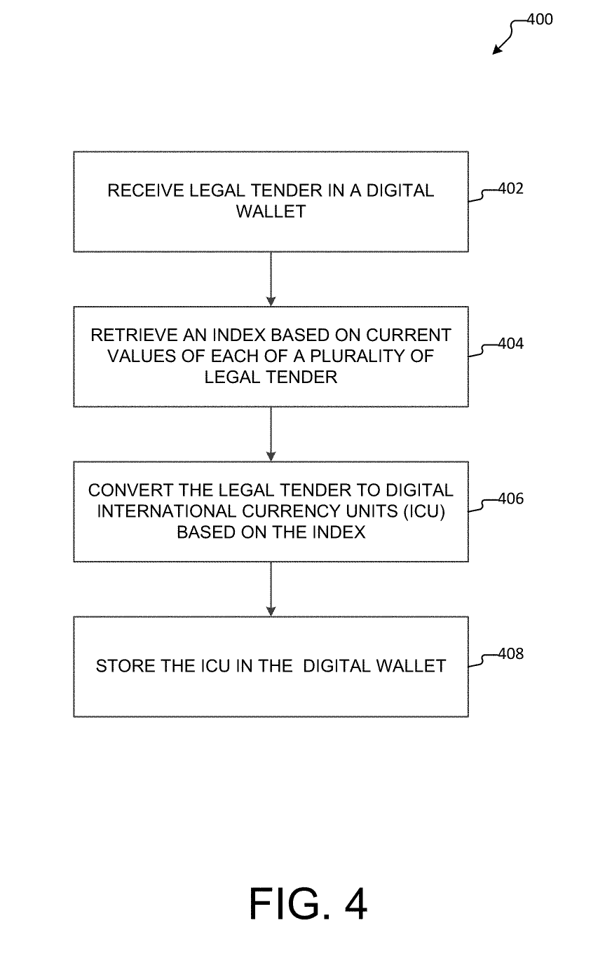

FIG. 4 illustrates an exemplary method for converting legal tender into international currency units (ICU) based on the index.

Method 400 begins with receive operation 402, where legal tender is received in a digital wallet. As described above, legal tender may include real-world currencies, precious metals, precious stones, etc. For instance, a buyer may transfer legal tender into a digital wallet associated with the buyer and hosted by an ICU platform. In aspects, a buyer may initiate a bank transfer or credit card transaction to transfer legal tender into the digital wallet, or the buyer may secure the digital wallet with tangible tender such as gold.

At retrieve operation 404, an index may be retrieved. As detailed above, the index may be calculated based at least in part on a current value of each of a plurality of legal tender. In some cases, the index may further be based at least in part on a relative weight for each of the plurality of legal tender. For instance, the index may be calculated as a weighted average of the current values. Alternatively, the index may be based on any suitable function of the current values of each of the plurality of legal tender. In further aspects, the index may be recalculated based on the current values of the plurality of legal tender at a predetermined time (at noon, at the top of the hour, etc.) on a predetermined interval (e.g., daily, hourly, minute-by-minute, second-by second, etc.).

At convert operation 406, the legal tender may be converted to international currency units (ICU) based on the index. For instance, an exchange component of the ICU platform may convert the legal tender into ICU based on the index. As should be appreciated, fluctuations in the value of legal tender over time are minimized where the legal tender is converted to ICUs, which are tied to the current values of a plurality of legal tender. Accordingly, stability is increased and perceived risk is decrease by converting legal tender to ICUs, thereby promoting international transactions.

At store operation 408, the ICUs are stored in the digital wallet. In some aspects, the digital wallet may be associated with a buyer and the ICUs may be available for performing a transaction via the ICU platform. For instance, ICUs from the user's digital wallet may be tagged to a digital contract and may be released to a seller upon delivery of an asset to the buyer.

As should be appreciated, FIG. 4 is described for purposes of illustrating the present methods and systems and is not intended to limit the disclosure to a particular sequence of steps, e.g., steps may be performed in differing order, additional steps may be performed, and disclosed steps may be excluded without departing from the present disclosure.

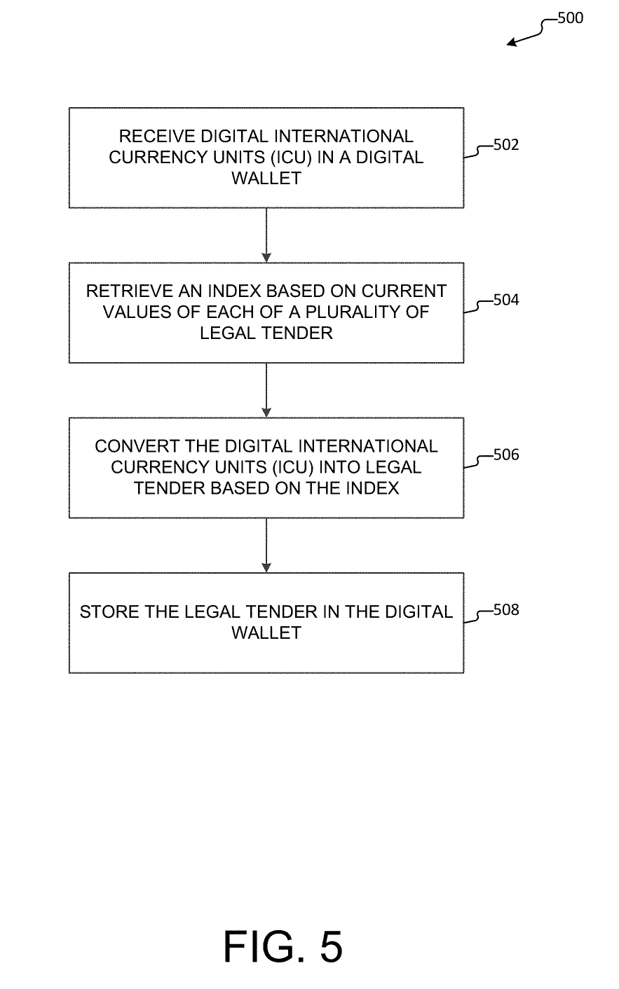

FIG. 5 illustrates an exemplary method for converting international currency units (ICU) into legal tender based on the index.

Method 500 begins with receive operation 502, where international currency units (ICU) are received in a digital wallet. As described above, an ICU is a form of digital currency that is tied to real-world legal tender based on an index. In aspects, based on the tie between ICUs and the index representative of real-world legal tender, ICUs exhibit increased value stability and decreased risk.

At retrieve operation 504, an index may be retrieved. As detailed above, the index may be based on current values of one or more types of legal tender, e.g., currencies, precious metals, precious stones, etc. The current value of each of the plurality legal tender may be based on its current exchange rate on a reliable market (e.g., London market, New York market, Tokyo market, etc.) and may be combined within the index on a regular, real-time basis (e.g., every minute on the minute, every hour on the hour, every day at the same time, etc.). For instance, the values of the plurality of legal tender may be combined within the index based on a simple average, a weighted average, or any other suitable function of the current values.

At convert operation 506, the ICUs may be converted into legal tender based on the index. For instance, an exchange component of the ICU platform may convert the ICUs to legal tender based on the index. As should be appreciated, risk due to fluctuations in the value of legal tender is minimized where the legal tender is converted to ICUs during a delay period of a transaction. Accordingly, value stability is increased by converting legal tender to ICUs, thereby promoting international contracts. After a transaction, ICUs may be converted to legal tender based on the index. That is, the index may serve as an exchange factor for converting the ICUs back to legal tender. As described above, legal tender may include real-world currencies, precious metals, precious stones, etc.

At store operation 508, the legal tender may be stored in the digital wallet. In some aspects, the digital wallet may be associated with a seller and the legal tender may be available for withdrawal following a transaction. For instance, upon delivery of an asset, ICUs may be released to digital wallet of the seller and converted into legal tender automatically or upon request by the seller. The legal tender may be in the form of the native currency of the seller or in any other form.

As should be appreciated, FIG. 5 is described for purposes of illustrating the present methods and systems and is not intended to limit the disclosure to a particular sequence of steps, e.g., steps may be performed in differing order, additional steps may be performed, and disclosed steps may be excluded without departing from the present disclosure.

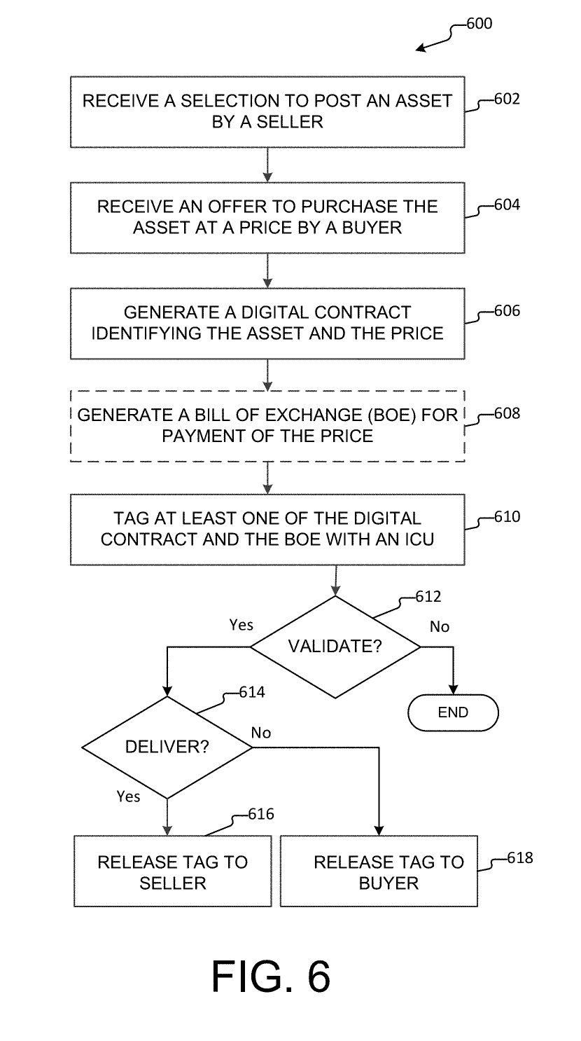

FIG. 6 illustrates an exemplary method for performing a digital contract using international currency units (ICU).

Method 600 begins at receive selection operation 602, where a selection to post an asset is received by an ICU platform. As detailed above, the ICU platform may provide an interface such that a seller may post an asset such as equity (e.g., in a business venture, company, invention, etc.), goods, services, property (real, personal, or intellectual), and the like. As used herein, “posting” an asset includes making the asset available to other users for investment, sale, lease, bid, etc. For instance, the interface associated with the ICU platform may include an asset listing for displaying posted assets to potential buyers.

At receive offer operation 604, the ICU platform may receive an offer from a buyer to purchase the asset at a price. In aspects, the interface of the ICU platform may provide an input field such that the buyer may communicate the offered price for the asset to the seller. As described above, the ICU platform may provide for multiple back and forth negotiations between one or more buyers and the seller with regard to the asset, price, performance time, etc. For instance, negotiations may involve discussions regarding characteristics of the asset (e.g., percentage ownership, guaranteed return, quantity, quality, warrantees, etc.), requirements for delivery of the asset (e.g., free of encumbrances, proof of title, risk of transport to buyer or seller, etc.), methods of payment (e.g., a bill of exchange, etc.), and the like.

At generate digital contract operation 606, a digital contract may be generated by the ICU platform upon acceptance of the offered price by the seller. That is, upon agreement by a buyer and a seller as to at least the asset and the price, a digital contract may be generated. In some cases, the buyer and the seller may further agree to additional terms, such as a performance time, characteristics of the asset, method of payment, etc. The generated digital contract may identify at least the asset and the price, and may further include any additional conditions or terms agreed to by the buyer and seller. As described herein, the generated digital contract may be a smart contract, which is a digital agreement that is formed, verified, and/or enforced within a computer-implemented environment.

At optional generate BOE operation 608, a bill of exchange may be generated as an instrument for satisfying the digital contract. As described above, a BOE is a written commitment by a funding party (buyer) to pay a certain sum either on demand or at a specified time, where the certain sum is paid to a specified funded party (seller) or to one presenting the bill of exchange. A digital BOE may be redeemable and transferrable and may contain proof of ownership, deed information and/or access to funds by the bearer of the BOE. In aspects, the BOE may be generated as a method of payment for the buyer to provide all or some portion of the agreed price for the asset to the seller.

At tag operation 610, at least one of the digital contract and the BOE may be tagged with an amount of international currency units. For instance, the digital contract or the BOE may be tagged with ICUs as a guarantee of payment by the buyer. An ICU tag may represent an amount of funds in the form of ICUs supplied by the buyer to secure the digital contract or BOE. The ICU tag may represent the full price or any portion thereof, e.g., down payment, earnest money, etc. In some aspects, the buyer may authorize the ICU tag to be associated with the digital contract or BOE at a formation time, T₁. As further described above, an ICU is a form of digital currency tied to a plurality of real-world legal tender (e.g., a plurality of real-world currencies) based on an index.

At determination operation 612, the ICU tag may be validated for the digital contract or BOE. For instance, validation may be accomplished using a blockchain, which is a public ledger of all transactions hosted by the ICU platform. As detailed above, a value attributable to the buyer's digital wallet may be determined at any given time in the history of the blockchain, serving as confirmation that the funds pledged (i.e., the ICU tag) are sufficient for the transaction and preventing “double-spending” of ICU. If the ICU tag is validated, the method may proceed to determination operation 614. Otherwise, if the ICU tag is not validated, the method may end.

At determination operation 614, upon validation of the ICU tag, it may be determined whether the asset was conveyed to the buyer. If the asset was conveyed to the buyer, the method may proceed to release operation 616. Otherwise, if the asset was not conveyed to the buyer, the method may proceed to release operation 618.

At release operation 616, upon confirmation of delivery of the asset, the ICU tag may be released to the seller. In some aspects, the ICU tag may be retagged to the seller and funds in the form of ICUs may be automatically added to a digital wallet associated with the seller. Alternatively, an exchange component of ICU platform may convert the ICUs to any real-world legal tender based on an index. For instance, the real-world legal tender may be the native currency of the seller or any other real-world or digital currency. As should be appreciated, fluctuations in the value of real-world legal tender between a formation time and a performance time of the digital contract are minimized where the legal tender is converted to ICUs during the delay period. In this regard, stability is increased and perceived risk is reduced, promoting international contracts.

At release operation 618, where the asset was not conveyed to the buyer, the ICU tag may be released back to the buyer. In further aspects, the ICU tag may be released back to the buyer in the case of a defective asset. In this case, the buyer may reject delivery of the asset and the ICU tag may be released back to the buyer. In some aspects, upon release, the ICU tag may be automatically added back to a digital wallet associated with the buyer.

As should be appreciated, FIG. 6 is described for purposes of illustrating the present methods and systems and is not intended to limit the disclosure to a particular sequence of steps, e.g., steps may be performed in differing order, additional steps may be performed, and disclosed steps may be excluded without departing from the present disclosure.

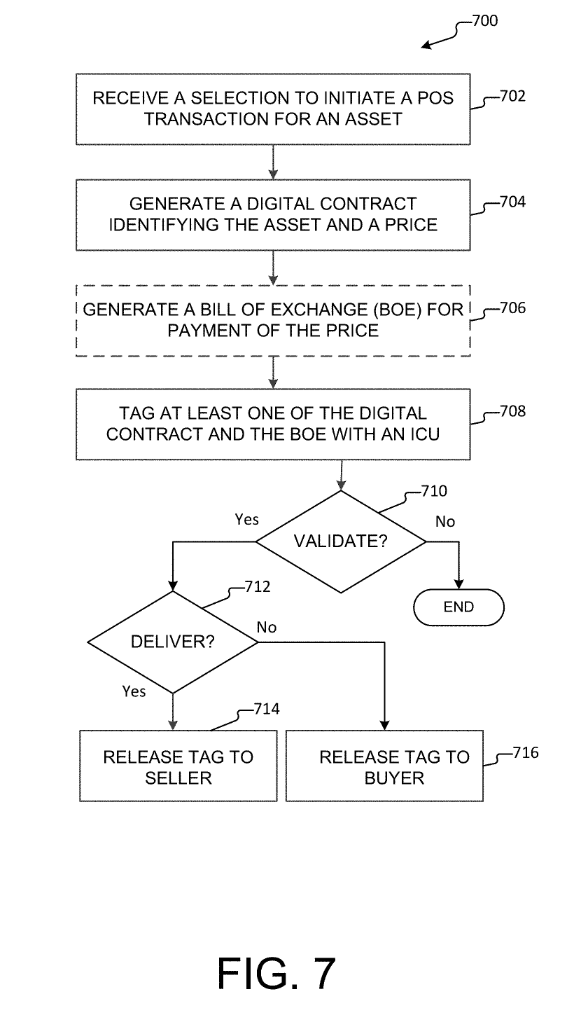

FIG. 7 illustrates an exemplary method for performing a point-of-sale (POS) transaction based on transfer of international currency units (ICU).

Method 700 begins at receive selection operation 702, where a selection to initiate a point-of-sale transaction is received by an ICU platform. As detailed above, the ICU platform may provide a POS interface such that a buyer may select an asset for purchase and may initiate a POS transaction. In aspects, the asset may be provided by a merchant at an advertised price. In aspects, the POS interface may be hosted by or associated with the merchant and the POS interface may communicate with the ICU platform.

At generate digital contract operation 704, a digital contract may be generated by the ICU platform upon initiating the POS transaction. That is, a digital contract may be generated for the selected asset at the advertised price. As described herein, the generated digital contract may be a smart contract, which is a digital agreement that is formed, verified, and/or enforced within a computer-implemented environment.

At optional generate BOE operation 706, a bill of exchange may be generated as an instrument for satisfying the digital contract. As described above, a BOE is a written commitment by the buyer to pay a certain sum (e.g., advertised price) either on demand or at a specified time, where the certain sum is paid to the seller or to one presenting the BOE. A digital BOE may be redeemable and transferrable and may contain proof of ownership, deed information and/or access to funds by the bearer of the BOE. In aspects, the BOE may be generated as a method of payment for the buyer to provide all or some portion of the advertized price for the asset to the seller.

At tag operation 708, at least one of the digital contract and the BOE may be tagged with an amount of international currency units. For instance, the digital contract or the BOE may be tagged with ICUs as a guarantee of payment by the buyer. An ICU tag may represent an amount of funds in the form of ICUs supplied by the buyer to secure the digital contract or BOE. The ICU tag may represent the full price or any portion thereof, e.g., down payment, earnest money, etc. In some aspects, the buyer may authorize the ICU tag to be associated with the digital contract or BOE at a formation time, T₁. As further described above, an ICU is a form of digital currency tied to a plurality of real-world currencies based on an index.

At determination operation 710, the ICU tag may be validated for the digital contract or BOE. For instance, validation may be accomplished using a blockchain, which is a public ledger of all transactions hosted by the ICU platform. As detailed above, a value attributable to the buyer's digital wallet may be determined at any given time in the history of the blockchain, serving as confirmation that the funds pledged (i.e., the ICU tag) are sufficient for the transaction and preventing “double-spending” of ICU. If the ICU tag is validated, the method may proceed to determination operation 712. Otherwise, if the ICU tag is not validated, the method may end.

At determination operation 712, upon validation of the ICU tag, it may be determined whether the asset was conveyed to the buyer. If the asset was conveyed to the buyer, the method may proceed to release operation 714. Otherwise, if the asset was not conveyed to the buyer, the method may proceed to release operation 716.

At release operation 714, upon confirmation of delivery of the asset, the ICU tag may be released to the seller. In some aspects, the ICU tag may be retagged to the seller and funds in the form of ICUs may be automatically added to a digital wallet associated with the seller. Alternatively, an exchange component of ICU platform may convert the ICUs to any real-world legal tender based on an index. For instance, the real-world legal tender may be the native currency of the seller or any other real-world or digital currency. As should be appreciated, fluctuations in the value of real-world legal tender between a formation time and a performance time of the digital contract are minimized where the legal tender is converted to ICUs during the delay period. In this regard, stability is increased and perceived risk is reduced, promoting international contracts.

At release operation 716, if the asset was not conveyed to the buyer, the ICU tag may be released back to the buyer. In further aspects, the ICU tag may be released back to the buyer in the case of a defective asset. In this case, the buyer may reject delivery of the asset and the ICU tag may be released back to the buyer. In some aspects, upon release, the ICU tag may be automatically added back to a digital wallet associated with the buyer.

As should be appreciated, FIG. 7 is described for purposes of illustrating the present methods and systems and is not intended to limit the disclosure to a particular sequence of steps, e.g., steps may be performed in differing order, additional steps may be performed, and disclosed steps may be excluded without departing from the present disclosure.

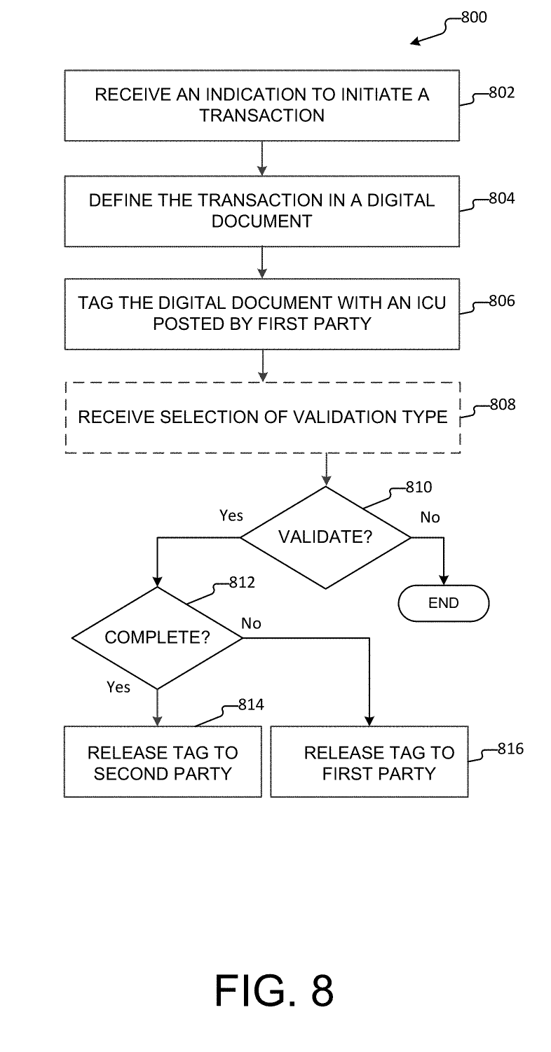

FIG. 8 illustrates an exemplary method for performing a transaction based on transfer of international currency units (ICU).

Method 800 begins at receive indication operation 802, where an indication to initiate a transaction is received. In aspects, the indication may be received via any suitable means, e.g., by selecting a “buy” icon embedded in a user interface of a webpage, by initiating an indication to exchange currency (e.g., via a private banking website), by initiating a transaction within the ICU platform, and the like. As detailed above, the ICU platform may provide an interface for initiating a transaction. In aspects, the transaction may comprise any digital transaction, including buying or selling an asset, exchanging currency, entering into a contract for future performance, etc.

At define operation 804, the transaction may be defined in a digital document. In aspects, “defining” the transaction may include, at least, describing the purpose of the transaction (e.g., buy, sell, invest, exchange, etc.) and any applicable terms. Terms may include a description of an asset, an agreed price of an asset, a performance deadline, an exchange rate, a description of the parties (e.g., contact information), and the like. In some aspects, the digital document may be an online form, a digital contract, or any other digital memorialization of the transaction.

At tag operation 806, the digital document may be tagged with an amount of international currency units. For instance, the digital document may be tagged with ICUs as a guarantee of payment by the buyer or a guarantee of deposited funds by an investor, etc. An ICU tag may represent an amount of funds in the form of ICUs supplied by a first party to secure the transaction. The ICU tag may represent the full price or any portion thereof, e.g., down payment, earnest money, etc. In some aspects, the first party may authorize the ICU tag to be associated with the digital document at a formation time, T₁. As further described above, an ICU is a form of digital currency tied to a plurality of real-world currencies based on an index.

At optional receive operation 808, a type of validation may be received by one or both parties. For example, validation of the transaction may be performed by a blockchain. In aspects, the blockchain may be a public blockchain, a private blockchain, or some combination of different side chains hosted by different entities. In some aspects, the selected blockchain may be agnostic, i.e., the blockchain may not be hosted by any particular entity but by many designated entities. A selection of the validation type may be received by any suitable means at any suitable time. For instance, the validation type may be selected upon initiation of the transaction, formation of a contract, at the time of performance, etc. In some aspects, rather than receiving a selection of a validation type, the validation type may be selected automatically by the system based on any appropriate criteria, including types of currency involved, availability of various blocks in a blockchain, validation time associated with different validation types, etc.

At determination operation 810, the ICU tag may be validated for the digital document. For instance, validation may be accomplished using the validation type indicated above. In some cases, validation may be performed using a blockchain, which is a ledger of all transactions hosted by a public entity, a private entity, the ICU platform, or otherwise. As detailed above, a value attributable to the buyer's digital wallet may be determined at any given time in the history of the blockchain, serving as confirmation that the funds pledged (i.e., the ICU tag) are sufficient for the transaction and preventing “double-spending” of ICU. If the ICU tag is validated, the method may proceed to determination operation 812. Otherwise, if the ICU tag is not validated, the method may end.

At determination operation 812, upon validation of the ICU tag, it may be determined whether the transaction was completed, e.g., the asset was conveyed to the buyer, the currency was exchanged, shares were released, etc. If the transaction was completed, the method may proceed to release operation 814. Otherwise, if the transaction was not completed, the method may proceed to release operation 816.

At release operation 814, upon confirmation that the transaction was completed, the ICU tag may be released to the second party. In some aspects, the ICU tag may be retagged to the second party and funds in the form of ICUs may be automatically added to a digital wallet associated with the second party. Alternatively, an exchange component of ICU platform may convert the ICUs to any real-world legal tender based on an index. For instance, the real-world legal tender may be the native currency of the second party or any other real-world or digital currency. As should be appreciated, fluctuations in the value of real-world legal tender between a formation time and a performance time of the transaction are minimized where the legal tender is converted to ICUs during the delay period. In this regard, stability is increased and perceived risk is reduced, promoting international trade.

At release operation 816, if the transaction was not completed, the ICU tag may be released back to the first party. In further aspects, the ICU tag may be released back to the first party in the case of a defective asset, a change in conditions, etc. In this case, the first party may reject delivery of the asset and the ICU tag may be released back to the first party. In some aspects, upon release, the ICU tag may be automatically added back to a digital wallet associated with the first party. In some cases, an exchange component of ICU platform may convert the ICUs to any real-world legal tender based on an index. For instance, the real-world legal tender may be the native currency of the first party or any other real-world or digital currency. As should be appreciated, fluctuations in the value of real-world legal tender between a formation time and a performance time of the transaction are minimized where the legal tender is converted to ICUs during the delay period. In this regard, stability is increased and perceived risk is reduced, promoting international trade.

As should be appreciated, FIG. 8 is described for purposes of illustrating the present methods and systems and is not intended to limit the disclosure to a particular sequence of steps, e.g., steps may be performed in differing order, additional steps may be performed, and disclosed steps may be excluded without departing from the present disclosure.

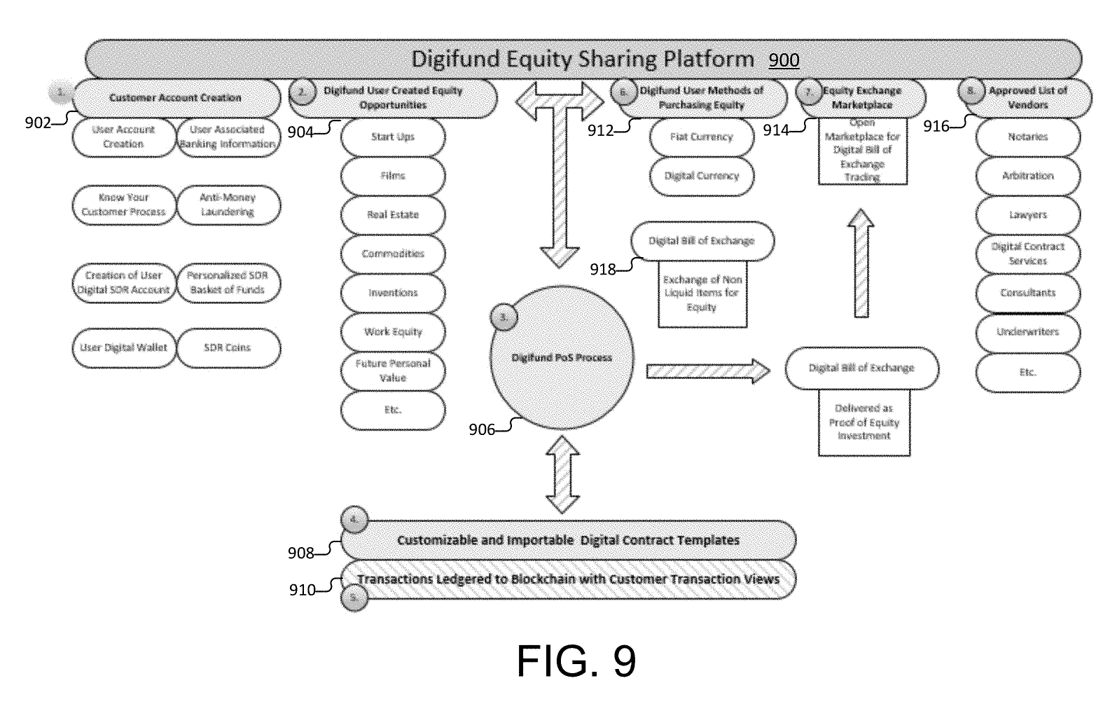

FIG. 9 illustrates a block diagram of a sharing platform based on international currency units (ICU).

Sharing platform 900 provides for investment of ICUs in equity funding opportunities. To participate in sharing platform 900, a customer account 902 is created. Creating the customer account 902 may include inputting or creating information such as but not limited to banking information, various customer processes, a personalized basket of international currencies for generating an index for valuing ICUs, a digital wallet, etc.

Sharing platform 900 may further provide an interface for entities to post or create equity opportunities 904. Equity opportunities may include, for example, investment in start-ups, film production, real estate, commodities, inventions, work equity, future personal value, and the like.

Sharing platform 900 may further involve an ICU process flow 906. The ICU process flow 906 may include any of the process flows described herein for satisfying transactions using ICUs. For example, process flow 906 may be include one or more aspects of methods 400, 500, 600, 700 or 800.

Sharing platform 900 may further include customizable additions to the process flow 906, including customizable or importable digital contract templates 908 or one or more blockchains 910. As detailed previously, blockchains 910 described herein may be agnostic and my comprise any blockchain currently known or developed in the future, as well as combinations of blockchains to create blockchain side chains.

Sharing platform 900 may further involve creating an investor account or providing an investor interface 912. The investor account or investor interface 912 may include features for exchanging fiat currency or other digital currencies with ICUs. The investor account or investor interface 912 may further involve a digital bill of exchange (BOE) interface 918 for creating or entering into a digital BOE, as described above. The digital BOE interface may facility transactions for investing in the equity opportunities 904.

Sharing platform 900 may further include an equity exchange marketplace 914. The equity exchange marketplace 914 may enable investment or trading using digital BOEs.

Sharing platform 900 may further include an approved list of vendors 916 for facilitating transactions hosted by the sharing platform 900. For example, the approved list of vendors may include but is not limited to notary publics, arbitration service providers, lawyers, digital contract services, consultants, underwriters, etc.

As should be appreciated, the various devices, components, etc., described with respect to FIG. 9 are not intended to limit the systems and methods to the particular components described. Accordingly, additional topology configurations may be used to practice the methods and systems herein and/or some components described may be excluded without departing from the methods and systems disclosed herein.

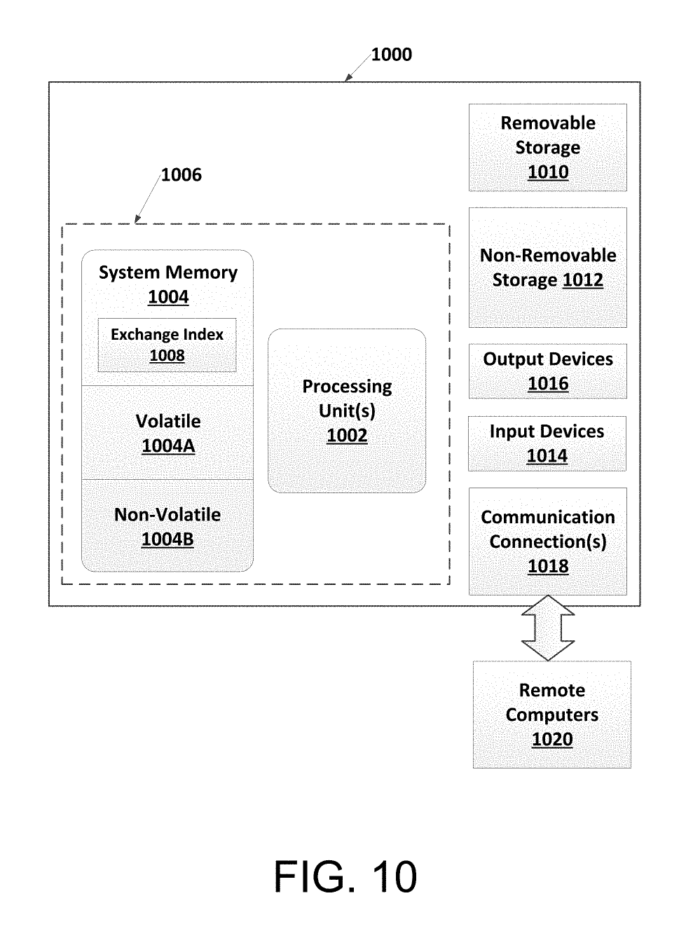

FIG. 10 illustrates one example of a suitable operating environment in which one or more of the present embodiments may be implemented.

FIG. 10 and the additional discussion in the present specification are intended to provide a brief general description of a suitable computing environment in which the present invention and/or portions thereof may be implemented. Although not required, the embodiments described herein may be implemented as computer-executable instructions, such as by program modules, being executed by a computer, such as a client workstation or a server. Generally, program modules include routines, programs, objects, components, data structures and the like that perform particular tasks or implement particular abstract data types. Moreover, it should be appreciated that the invention and/or portions thereof may be practiced with other computer system configurations, including hand-held devices, multi-processor systems, microprocessor-based or programmable consumer electronics, network PCs, minicomputers, mainframe computers and the like. The invention may also be practiced in distributed computing environments where tasks are performed by remote processing devices that are linked through a communications network. In a distributed computing environment, program modules may be located in both local and remote memory storage devices.

FIG. 10 illustrates one example of a suitable operating environment 1000 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 1000 typically includes at least one processing unit 1002 and system memory 1004. Depending on the exact configuration and type of computing device, system memory 1004 (storing, among other things, an exchange index 1008 for performing the methods disclosed herein, etc.) may be volatile 1004A (such as RAM), non-volatile 1004B (such as ROM, flash memory, etc.), or some combination of the two. This most basic configuration is illustrated in FIG. 10 by dashed line 1006. Further, environment 1000 may also include storage devices (removable 1010, and/or non-removable 1012) including, but not limited to, magnetic or optical disks or tape. Similarly, environment 1000 may also have input device(s) 1014 such as keyboard, mouse, pen, voice input, etc. and/or output device(s) 1016 such as a display, speakers, printer, etc. Also included in the environment may be one or more communication connections 1018, such as LAN, WAN, point to point, etc.

Operating environment 1000 typically includes at least some form of computer readable media. Computer readable media can be any available media that can be accessed by processing unit 1002 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 1000 may be a single computer operating in a networked environment using logical connections to one or more remote computers 1020. The remote computers 1020 may be personal computers, servers, routers, network PCs, peer devices or other common network node, or any combination thereof, and typically include many or all of the elements described above as well as others not so mentioned. The logical connections may include any method supported by available communications media. Such networking environments are commonplace in offices, enterprise-wide computer networks, intranets and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processing unit; and
at least one memory storing computer executable instructions that, when executed by the at least one processing unit, cause the system to perform a method, the method comprising:
receiving an indication to initiate a transaction;
generating a digital document defining the transaction;
tagging the digital document with an amount of international currency units (ICU);
validating the ICU tag; and
in response to validating the ICU tag, releasing the amount of ICU.

2. The system of claim 1, further comprising:
generating a bill of exchange (BOE).

3. The system of claim 2, further comprising:
tagging at least one of the digital document or the BOE with an amount of ICU.

4. The system of claim 1, further comprising:
prior to releasing the amount of ICU, determining whether the transaction has been completed.

5. The system of claim 4, wherein when the transaction has not been completed, releasing the amount of ICU to a first party.

6. The system of claim 4, wherein when the transaction has been completed, releasing the amount of ICU to a second party.

7. The system of claim 1, wherein an ICU is a unit of digital currency tied to values of each of a plurality of real-world currencies based on an index.

8. The system of claim 7, wherein the amount of ICU is converted to an amount of a real-world currency based on the index.

9. The system of claim 7, wherein the index is calculated in near real time based on current values of each of the plurality of real-world currencies.

10. The system of claim 9, wherein the index is a weighted function of the current values of each of the plurality of real-world currencies.

11. A method of performing a point-of-sale (POS) transaction using an international currency unit (ICU), the method comprising:
receiving a selection to initiate a POS transaction for an asset;
generating a digital document;
tagging the digital document with an amount of international currency units (ICU);
validating the ICU tag; and
in response to validating the ICU tag, releasing the amount of ICU.

12. The method of claim 11, further comprising:
generating a bill of exchange (BOE).

13. The method of claim 12, further comprising:
tagging at least one of the digital document or the BOE with an amount of ICU.

14. The method of claim 11, further comprising:
prior to releasing the amount of ICU, determining whether the asset has been delivered.

15. The method of claim 14, wherein when the asset has not been delivered, releasing the amount of ICU to a buyer.

16. The method of claim 14, wherein when the asset has been delivered, releasing the amount of ICU to a seller.

17. The method of claim 11, wherein an ICU is a unit of digital currency tied to values of each of a plurality of real-world currencies based on an index.

18. The method of claim 17, wherein the index is calculated in near real time based on current values of each of the plurality of real-world currencies.

19. A computer storage medium storing computer-readable instructions that when executed by a processor cause a computing system to:
receive a selection to purchase an asset at a price;
generate a digital document;
tag the digital document with an amount of international currency units (ICU);
validate the ICU tag; and
in response to validating the ICU tag, release the amount of ICU.

20. The computer storage medium of claim 19, wherein an ICU is a unit of digital currency tied to values of each of a plurality of real-world currencies based on an index.
